(19) United States
(12) Patent Application Publication
(10) Pub. No.: US 2010/0057539 A1
(43) Pub. Date: Mar. 4, 2010

(54) Internet-based location intelligence system

(76) Inventor: Matthew Emmerson Allen, Arundel (GB)

Correspondence Address: Matthew Emmerson Allen, The Lodge, 2 Ford Road, Arundel, West Sussex, BN18 9EA, GB

(21) Appl. No.: 12/547,742

(22) Filed: Aug. 26, 2009

(30) Foreign Application Priority Data
Aug. 26, 2008 (GB) 08154403

(51) Int. Cl. G06F 17/30; G06F 7/10; G06Q 10/00; G06Q 30/00

(52) U.S. Cl. 705/10; 707/104.1; 707/5; 707/10; 707/E17.014; 707/E17.044; 707/3; 705/14.19

(57) ABSTRACT

An internet-based location intelligence system comprising,
A central data storage arranged to receive a signal at from a first remote electronic device which provides information concerning a location, including
a) When visit was/is, and/or
b) Reason for visit, and/or
c) Length of visit, and/or
d) size of travel group, and/or
e) how destination was reached/will be reached,
central data storage being arranged to receive a signal at a central data storage from a second remote electronic device which requests information regarding the same location,
central data storage being arranged to provide information to user at the second remote electronic device, and
central data storage being arranged to permit communication between the use of the second remote electronic device and the first remote electronic device so that information concerning the location can be shared.

The present application relates to an internet-based location intelligence system.

### BACKGROUND OF THE INVENTION

When a traveller intends to visit a location, particularly for the first time, the traveller often likes to obtain information about the location, for example, the best hotels, the best restaurants, and the best points of interest, before they go or whilst they are at the location. There are numerous sources of information relating to hotels, restaurants, and points of interest. However, a lot of the available information is provided directly or indirectly by owners and agents of hotels, restaurants, and points of interest. In contrast, a traveller would like to obtain information from an independent source, preferably a friend or at least a person they can trust. A traveller can email a friend or friends and request information, but this method requires a traveller to recall basic details of their friend's travels, or that a traveller email many or all of their friends, but this can be time consuming and wasteful.

One known internet-based location intelligence system is called the TripAdvisor™ Travel Map and is arranged to allow a Contributor who has already been to a location to input the name of the location which they have been to, and are able to advise friends on, using a personal computer connected to the internet. Information concerning users and locations is stored in a database. Subsequently, a friend who intends to visit a location is able to input the destination, and the system searches the database and displays Contributors that have been to the destination, so that the Searcher can communicate with a Contributor that has been to the destination.

An aim of the invention is to provide an improved system or at least one with additional functionality.

### SUMMARY OF THE INVENTION

According to a first aspect of the invention there is provided an internet-based location intelligence system comprising a central data storage which can be arranged in signal communication with one or more remote contributor electronic devices, wherein the central data storage is arranged to receive from each remote contributor electronic device, and store, in respect of the or each remote contributor electronic device:

a) a location which contributor has been or will be visited, and one or more, in any combination, of the following,

b)(i) when contributor has been or will be at location, and/or

b)(ii) why contributor has been or will be at location, and/or

b)(iii) how long contributor has been or will be at location, and/or

b)(iv) how big group of contributor was or will be, and/or

b)(v) how did or how will contributor get to location.

The internet-based location intelligence system in accordance with the invention permits organised collection of precise travel information from contributors.

The internet-based location intelligence system of the preceding paragraph may further comprise one or more remote search user electronic devices in signal communication with the central data storage, which allows a search user to:

select a location which will be visited, and, one or more, in any combination, of the following,

when they will be at location, and/or

why they will be at location, and/or

how long they will be at location, and/or

how big group of contributor will be, and/or

how will contributor get to location.

This permits exchange of pertinent travel information from an organised collection of precise travel information submitted by contributors to a search user which is relevant to the search user's selected location.

The internet-based location intelligence system of the preceding paragraph may be arranged to provide to one or more remote search user electronic devices,

a list of contributors that have been at location, and, one or more, in any combination, of the following,

when contributors have been or will be at location, and/or

why contributors have been or will be at location, and/or

how long contributors have been or will be at location, and/or

how big group of contributor was or will be, and/or

how did or will contributor get to location.

The internet-based location intelligence system of the preceding paragraph may be arranged so that results can be filtered according to best “when”, and/or “why”, and/or “how long”, and/or “how big”, and/or “how did” match between contributor(s) and search user, preferably “when”, “why”, “how long”, “how big”, and “how did” are each designated a weighting in the provision and/or display of results.

The internet-based location intelligence system of the preceding paragraph or the paragraph preceding that, wherein the system may be arranged to permit communication between the user of the second remote electronic device and the first remote electronic device so that information concerning the location can be shared.

The internet-based location intelligence system of the preceding paragraph may be arranged to permit the user of the second remote electronic device to recommend to the user of the first remote electronic device one or more place to stay, and/or place to eat, and/or place to drink, and/or points of interest.

The internet-based location intelligence system of the preceding paragraph may be arranged to allow the central storage to obtain recommendation(s), process recommendation(s), and attribute a point, vote or the like, to a recommended place, and the central storage is arranged to calculate the total number of points, votes or the like.

In the internet-based location intelligence system of the preceding paragraph, the central storage may be arranged to store total number of points, votes or the like in such a way that website users can view the total number of recommendations for a place to stay, and/or place to eat, and/or place to drink, and/or points of interest.

In the internet-based location intelligence system of one or more of the three preceding paragraphs, the central storage may be arranged to reward person making recommendation.

In the internet-based location intelligence system of one or more of the four preceding paragraphs, the central storage may be arranged to request feedback from search user regarding accuracy of recommendations.

In the internet-based location intelligence system of one or more of the five preceding paragraphs, the central storage may be arranged to receive feedback from search user regarding accuracy of recommendations.

In the internet-based location intelligence system of the preceding paragraph, the central storage may be arranged to reward search user for feedback.

In the internet-based location intelligence system of one or more of the two preceding paragraphs, the central storage may be arranged to reward contributor for each accurate recommendation.

In the internet-based location intelligence system of one or more of the eight preceding paragraphs excluding the immediately preceding paragraph, the central storage may be arranged to store total number of points, votes or the like relating to total number and/or accuracy of an individual's recommendations and let website users view a score or grade or the like relating to number and/or accuracy of their recommendations to fellow user.

According to a second aspect of the invention there is provided an internet based location selection interface, an internet based location selection database, or an internet based location selection search tool, substantially as described herein, with reference to the relevant accompanying Figure(s).

According to a third aspect of the invention there is provided a method of sharing data concerning a location, comprising the steps of:
Receiving a signal at a central data storage from a first remote electronic device which provides information concerning a location, including

a) When visit was/is, and/or

b) Reason for visit, and/or

c) Length of visit, and/or

d) size of travel group, and/or

e) how destination was reached/will be reached,
Receiving a signal at a central data storage from a second remote electronic device which requests information regarding the same location,
Providing information to user at the second remote electronic device,

The method of the preceding paragraph may comprise the additional step of:
Permitting communication between the use of the second remote electronic device and the first remote electronic device so that information concerning the location can be shared.

The method of one of the two preceding paragraphs may comprise the additional step of:

Allowing the results to be ranked depending on:

a) When visit was/is, and/or

b) Reason for visit, and/or

c) Length of visit.

The method of one of the three preceding paragraphs may comprise the additional step of:

Saving at least some of the information transmitted between the first remote electronic device and the second remote electronic device.

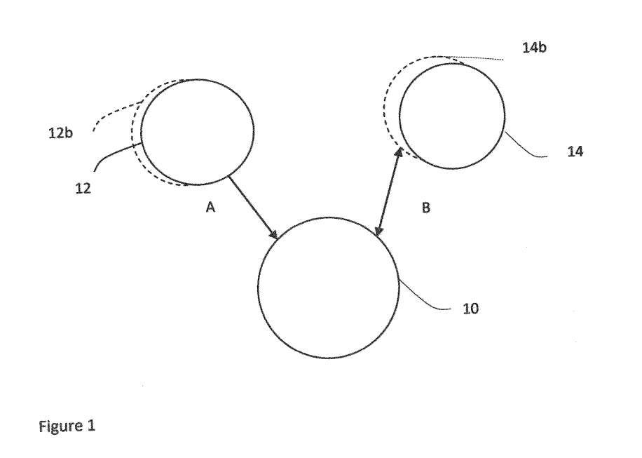

An internet-based location intelligence system, and its parts, will now be described by way of example only, and with reference to the accompanying drawings in FIGS. 1 to 19.

FIG. 1 is a schematic view of an internet-based location intelligence system in accordance with the invention,

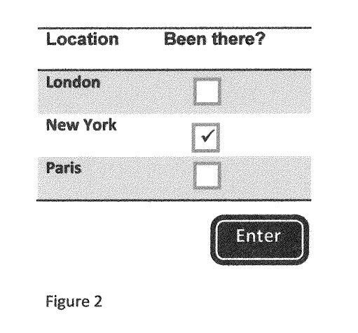

FIG. 2 is a view of a Contributor electronic device interface for communication with a data storage and data processor,

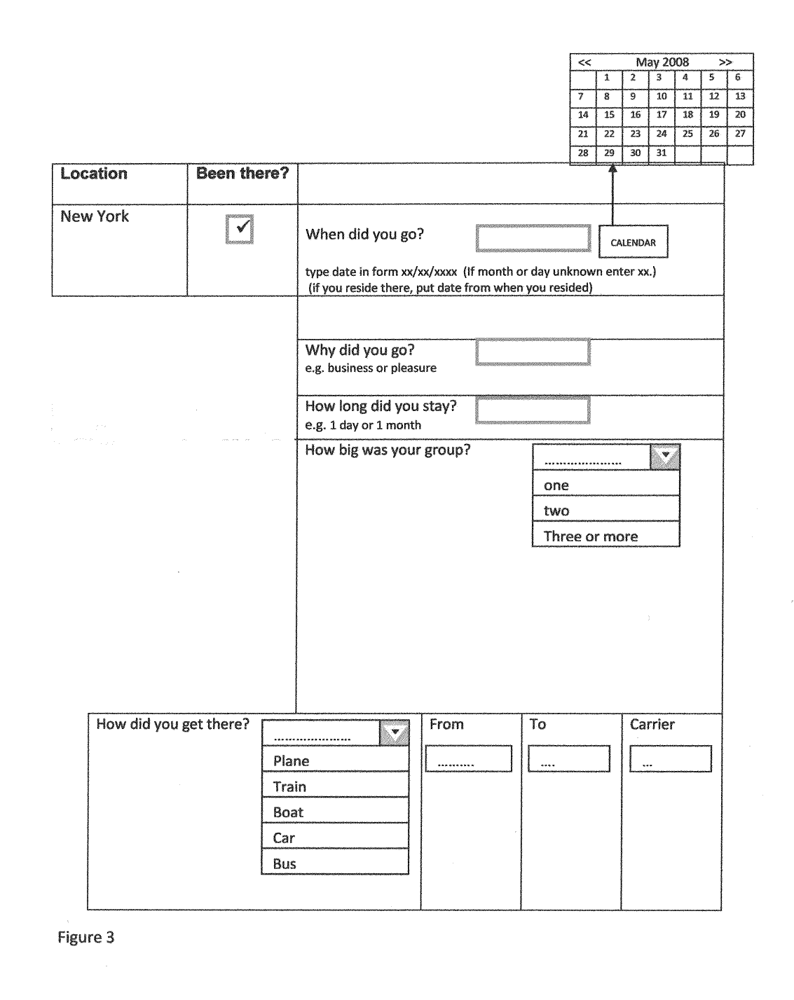

FIG. 3 is a further view of the interface following input from a Contributor,

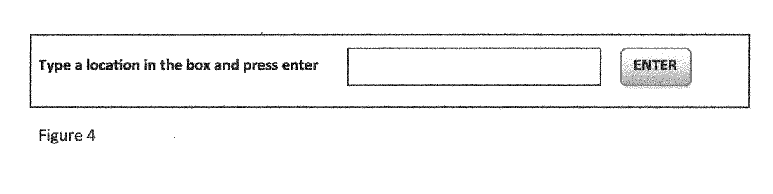

FIG. 4 is a view of a Search Interface for communication with a data storage and data processor,

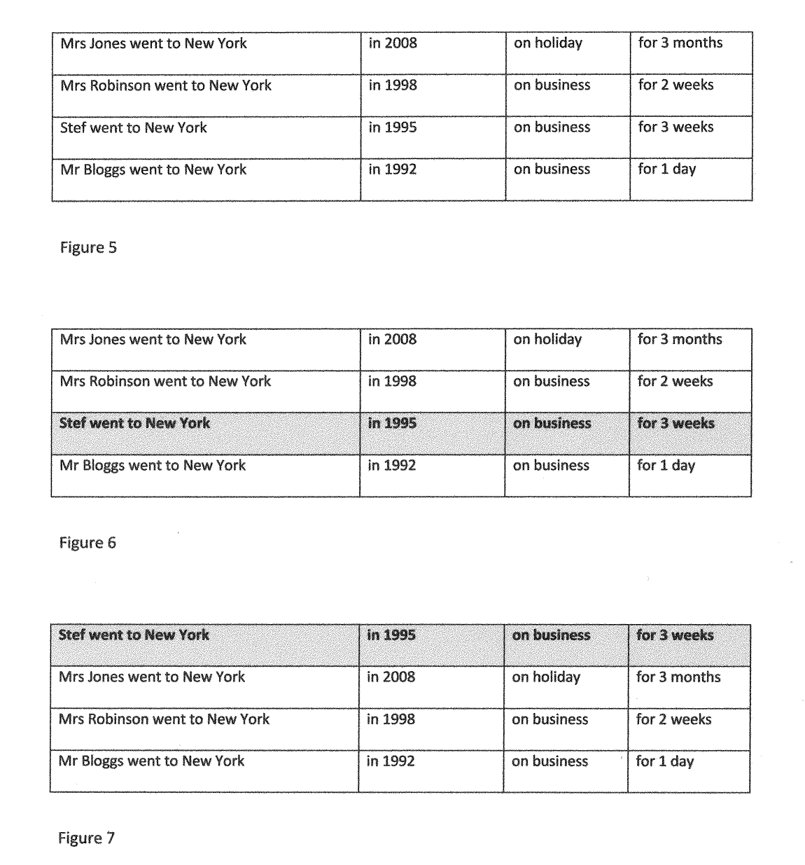

FIG. 5 is a further view of a Search Interface, following action by a Search User,

FIG. 6 is a further view of a Search Interface, following action by a Search User,

FIG. 7 is a further view of a Search Interface, following action by a Search User,

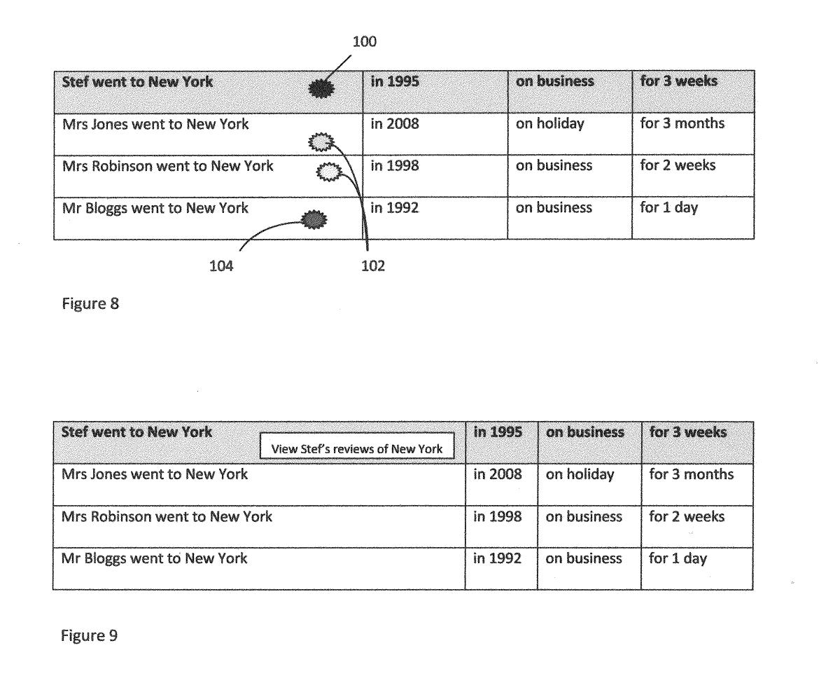

FIG. 8 is a further view of a Search Interface, following action by a Search User,

FIG. 9 is a further view of a Search Interface, following action by a Search User,

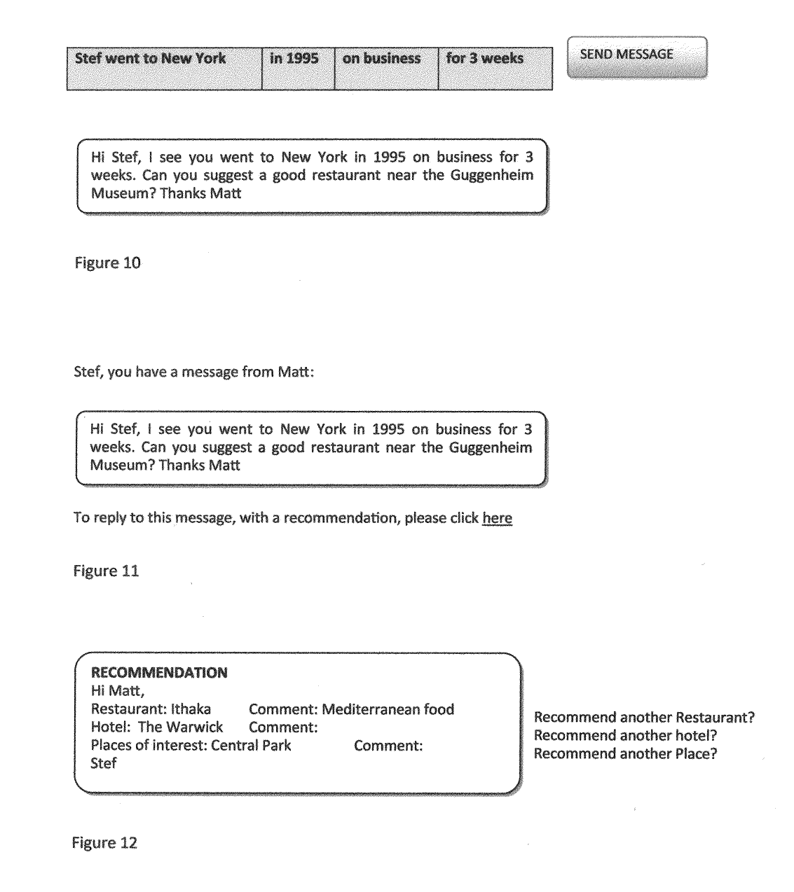

FIG. 10 is a further view of a Search Interface, following action by a Search User, showing initiation of a dialogue between Search User and Contributor,

FIG. 11 is a further view of a Search interface dialogue, showing delivery to the Contributor,

FIG. 12 is a further view of a Search interface dialogue, showing reply by the Contributor,

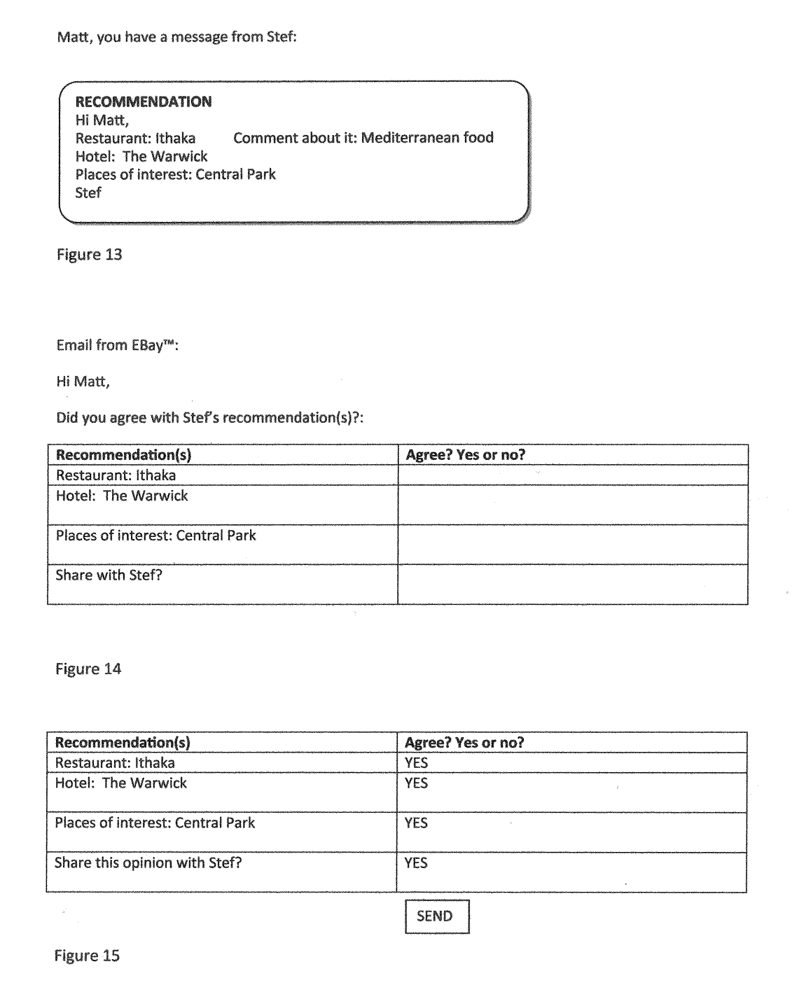

FIG. 13 is a further view of a Search interface dialogue, showing delivery to the Search User,

FIG. 14 is a Search User interface showing a communication from a service provider,

FIG. 15 is a Search User interface showing a reply to the service provider,

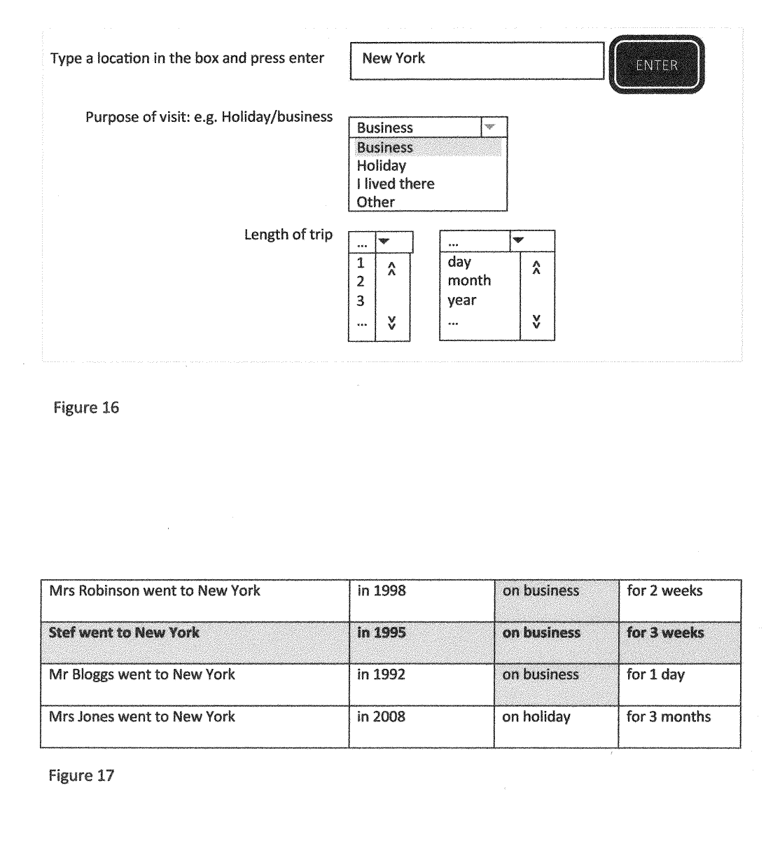

FIG. 16 is a further view of a Search Interface, following action by a Search User,

FIG. 17 is a further view of a Search Interface, following action by a Search User,

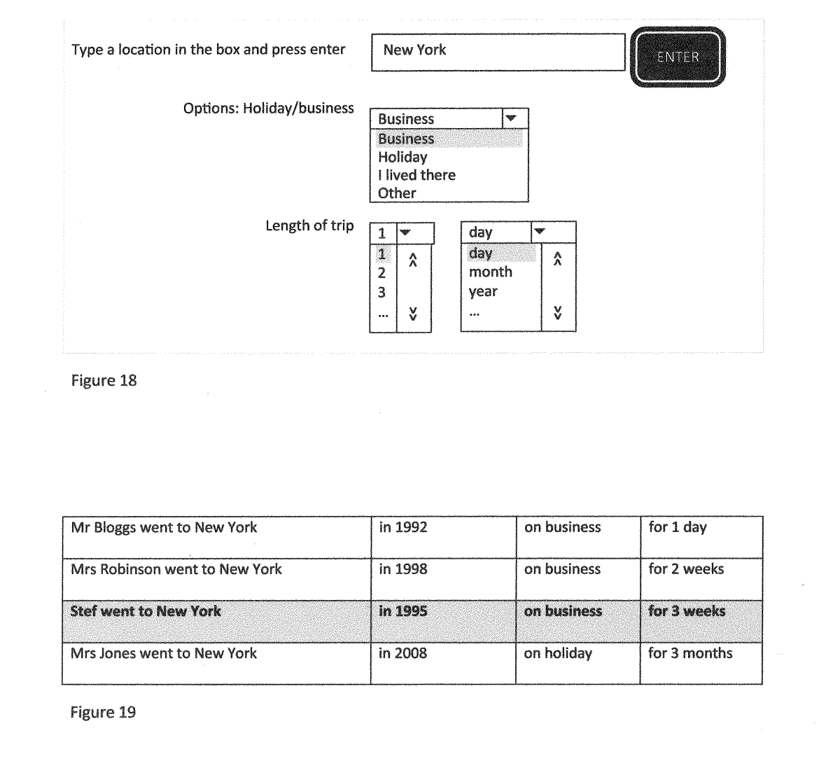

FIG. 18 is a further view of a Search Interface, following action by a Search User, and

FIG. 19 is a further view of a Search Interface, following action by a Search User.

### DESCRIPTION OF THE INVENTION

Referring to FIG. 1, a simplified internet-based location intelligence system comprises a data storage and data processor 10, a Contributor electronic device interface 12, and a Search User electronic device interface 14. The data storage and processor 10 is able to communicate with the Contributor interface 12 in both directions via a communication route A. The data storage and processor 10 is able to communicate with the Search User interface 14 in both directions via a communication route B. The Contributor interface 12 is able to communicate directly with the Search User interface 14 in both directions via a communication route C. Each Contributor interface 12, and each Search User interface 14 has suitable display screens. The data storage 10 comprises database fields.

In reality the system is a much bigger network, and will comprise numerous separate Contributor interfaces 12a, 12b, 12c, etc. representing numerous individual Contributors and numerous separate Search User interfaces 14a, 14b, 14c, etc. representing numerous individual Search Users. Each Contributor interface 12 is able to communicate with the data storage and processor 10 via one of numerous communication routes A1, A2, A3, etc. Each Search User interface 14 is able to communicate with the data storage and processor 10 via one of numerous communication routes B1, B2, B3, etc. Each Contributor interface 12 is able to communicate with each Search User interface 14 via one of numerous communication routes A1+B1, A2+B2, A3+B3, etc.

Referring to FIG. 2, as per the known TripAdvisor™ Travel Map system, a Contributor can input destinations which they have been to at a remote electronic device 12. The data can be input into a central storage means 10.

Referring to FIG. 3, in accordance with the invention, after indicating where the user is been, the central data storage and data processor 10 responds by asking the Contributor at the Contributor electronic device interface 12 the following questions:
1. When did you go?
2. Why did you go?
3. How long did you stay?
4. How big was your group?
5. How did you get there?

These questions are devised to permit a Contributor to provide useful information about their trip from recall, without requiring them to search through their records.

The more the table at FIG. 3 is completed, the more points are awarded to the Contributor. Once the Contributor obtains a certain number of points, they may be rewarded, for example with a discount on a travel booking on a predetermined website provider.

The above tool discussed at Steps 1 and 2 above can be used on locations that a person intends to visit, i.e. substitute ‘been there’ for ‘going there’, substitute ‘did you go’ for ‘will you go’, substitute ‘did you stay’ for ‘will you stay’.

The resulting answers obtained during Steps 1 and 2 above are stored in an appropriate database 10.

Referring to FIG. 4, a Search User can provide a location to the Search Interface 14, and a database 10 of the above type can be searched, to retrieve a list of Contributors who have visited the location or intend to.

Referring to FIG. 5, a list of Contributors relevant to the searched location is then retrieved from the database 10, and displayed on the display screen of the Search Interface 14.

Generally opinions of Contributors who have visited the location recently are more relevant. Accordingly, Contributors may be listed in date order.

Generally opinions of Contributors who have visited the location for a longer duration are more relevant. Accordingly, Contributors may be listed in order of time spent at location.

After entering just the location in step 1 and obtaining the above type result list, the Search User may in step 2 press an appropriate button to order the list of Contributors by date, reason for trip, or duration of trip.

Friends (of the Search User) may be highlighted in the list of Contributors as in FIG. 6 or placed at the top of the list as shown in FIG. 7.

In this way trusted advice can be obtained, particularly if Contributors are within a network of friends or the like.

In particular, if more than one Contributor has been to the location, a Search User can decide which Contributor has been for reasons most matching their own, and the Search User can approach the most appropriate Contributor for advice regarding the location. The Search User can contact via communication path a+b.

Referring to FIG. 8, an EBay™-like Advisor Rating may be placed against names of Contributors in the list to indicate reliability. The rating can be in the form of an instantly recognisable and comprehensible star, coloured gold 100, silver 102, or bronze 104 according to reliability of Advisor.

Referring to FIG. 9, the results table may include a link next to each person allowing a search user to view reviews made by the person to which the link relates.

Following the Search, a Search User may then begin a dialogue with one or more of the listed Contributors for information concerning the location, as exemplified below at FIG. 10.

The Contributor receives an email at their usual provider indicating a message obtained on the web based system, and, optionally, the content of the message, as shown in FIG. 11.

The Contributor can then click the mouse, followed by optional login steps, to respond with an appropriate recommendation concerning the location, as shown at FIG. 10. In this example, the advisor person is able to recommend a Restaurant, a Hotel, and a Place of interest.

Very importantly, the Search User trusts advice from this Contributor.

The Search User may receive, and view, the Recommendation in the same way, as shown in FIG. 13.

After a predetermined time period, the service provider can send an email to the Search User, asking if they agreed with the Recommendation(s), as shown at FIG. 14.

Optionally, the Search User may respond as shown at FIG. 15. This can have two effects. Firstly, if the Search User agrees with any recommendation, the hotel, restaurant or point of interest rating on the service providers will be positively influenced, thereby influencing its Popularity Rating on a ratings website. Secondly, if the Search User agrees, the Contributor is awarded with a point for each successful recommendation, e.g. 3 points total in the example given, thereby influencing their individual Advisor Rating.

Optionally, the Contributor may also advise a means of transport (“how to get there”).

Instead of categorising the matching people in two steps as described above, a user may provide more information at the initial stage as shown below and Contributors may be listed according to their ‘match’ with the user.

Requirements often change dramatically depending on the reason for the visit. Referring to FIG. 16, in addition to entering the location, the user may enter the “Purpose of visit”. Such a search will provide a results list of the same people, but in a different order according to their purpose of visit ‘match’, as shown in FIG. 17.

Requirements also often change dramatically depending on the length of the visit. Referring to FIG. 18, in addition to entering the location, the Search User may enter the “Length of visit”. Such as search will provide a results list of the same people, but in a different order according to their length of visit ‘match’, as shown in FIG. 19.

Requirements also often change dramatically depending on no of people in group. Optionally, one could integrate a “No. of people in group” option into the results.

A search user might be interested in “how many times” a contributor has visited a location, on the basis that a user tends to know a destination better the more they visit. Therefore, in a further embodiment of the invention, trips to a location can be counted and stored in the database, and the number of trips to a location can be communicated to a search user.

1. An internet-based location intelligence system comprising a central data storage which can be arranged in signal communication with one or more remote contributor electronic devices, wherein the central data storage is arranged to receive from each remote contributor electronic device, and store, in respect of the or each remote contributor electronic device:
a) a location which contributor has been or will be visited, and one or more, in any combination, of the following,
b)(i) when contributor has been or will be at location, and/or
b)(ii) why contributor has been or will be at location, and/or
b)(iii) how long contributor has been or will be at location, and/or
b)(iv) how big group of contributor was or will be, and/or
b)(v) how did or how will contributor get to location.

2. An internet-based location intelligence system according to claim 1, further comprising one or more remote search user electronic devices in signal communication with the central data storage, which allows a search user to:
select a location which will be visited, and, one or more, in any combination, of the following,
when they will be at location, and/or
why they will be at location, and/or
how long they will be at location, and/or
how big group of contributor will be, and/or
how will contributor get to location.

3. An internet based location intelligence system according to claim 2, wherein the system is arranged to provide to one or more remote search user electronic devices,
a list of contributors that have been at location, and, one or more, in any combination, of the following,
when contributors have been or will be at location, and/or
why contributors have been or will be at location, and/or
how long contributors have been or will be at location, and/or
how big group of contributor was or will be, and/or
how did or will contributor get to location.

4. An internet-based location intelligence system according to claim 3, wherein results can be filtered according to best “when”, and/or “why”, and/or “how long”, and/or “how big”, and/or “how did” match between contributor(s) and search user, preferably “when”, “why”, “how long”, “how big”, and “how did” are each designated a weighting in the provision and/or display of results.

5. An internet-based location intelligence system according to claim 3, wherein the system is arranged to permit communication between the user of the second remote electronic device and the first remote electronic device so that information concerning the location can be shared.

6. An internet-based location intelligence system according to claim 5, wherein the system is arranged to permit the user of the second remote electronic device to recommend to the user of the first remote electronic device one or more place to stay, and/or place to eat, and/or place to drink, and/or points of interest.

7. An internet-based location intelligence system according to claim 6, wherein the system is arranged to allow the central storage to obtain recommendation(s), process recommendation(s), and attribute a point, vote or the like, to a recommended place, and the central storage is arranged to calculate the total number of points, votes or the like.

8. An internet-based location intelligence system according to claim 7, wherein the central storage is arranged to store total number of points, votes or the like in such a way that website users can view the total number of recommendations for a place to stay, and/or place to eat, and/or place to drink, and/or points of interest.

9. An internet-based location intelligence system according to claim 6, wherein the central storage is arranged to reward person making recommendation.

10. An internet-based location intelligence system according to claim 6, wherein the central storage is arranged to request feedback from search user regarding accuracy of recommendations.

11. An internet-based location intelligence system according to claim 6, wherein the central storage is arranged to receive feedback from search user regarding accuracy of recommendations.

12. An internet-based location intelligence system according to claim 11, wherein the central storage is arranged to reward search user for feedback.

13. An internet-based location intelligence system according to claim 11, wherein the central storage is arranged to reward contributor for each accurate recommendation.

14. An internet-based location intelligence system according to claim 6, wherein the central storage is arranged to store total number of points, votes or the like relating to total number and/or accuracy of an individual's recommendations and let website users view a score or grade or the like relating to number and/or accuracy of their recommendations to fellow user.

15. A method of sharing data concerning a location, comprising the steps of:
Receiving a signal at a central data storage from a first remote electronic device which provides information concerning a location, including
a) When visit was/is, and/or
b) Reason for visit, and/or
c) Length of visit, and/or
d) size of travel group, and/or
e) how destination was reached/will be reached,
Receiving a signal at a central data storage from a second remote electronic device which requests information regarding the same location,
Providing information to user at the second remote electronic device,

16. A method according to claim 15, comprising the additional step of:
Permitting communication between the use of the second remote electronic device and the first remote electronic device so that information concerning the location can be shared.

17. A method according to claim 15, comprising the additional step of:
Allowing the results to be ranked depending on:
a) When visit was/is, and/or
b) Reason for visit, and/or
c) Length of visit.

18. A method according to claim 15, comprising the additional step of:
Saving at least some of the information transmitted between the first remote electronic device and the second remote electronic device.
